(19) United States
(12) Patent Application Publication
(10) Pub. No.: US 2017/0270552 A1
(43) Pub. Date: Sep. 21, 2017

(54) Multi-Level Marketing Streaming Video Surveillance Security

(71) Applicant: John Matthew Ellis, Redondo Beach, CA (US)

(72) Inventor: John Matthew Ellis, Redondo Beach, CA (US)

(21) Appl. No.: 15/432,768

(22) Filed: Apr. 18, 2017

Related U.S. Application Data
(60) Provisional application No. 62/295,748, filed on Feb. 16, 2016.

(51) Int. Cl. G06Q 30/02; G06Q 30/00; H04N 7/18; G06Q 50/18

(52) U.S. Cl. CPC G06Q 30/0214; G06Q 30/0213; G06Q 50/182; G06Q 30/0185; H04N 7/181

(57) ABSTRACT

A method for creating a network with a large number or people to view or review live or recorded video streaming from surveillance cameras to document thefts, other criminal acts or other activities which could create a loss to individuals, companies or others. People are recruited to view the videos with a multi-level marketing organization with different levels of membership. Compensation occurs to the multi-level marketing organization when loss through theft or other action is prevented or when the recorded video from members is used to secure payment to the individual, company or other that suffered a loss. Compensating to the multi-level organization is a contracted percentage of the loss prevented or payment(s) received from the offending party, and the compensation to members is a contracted percentage of the compensation received by the multi-level marketing organization. The effectiveness of process may be improved with a social media game highlighting each member's performance to the members at large and by adding a private policing network capable of both locating offending parties and reaching settlement between the offending party and individuals, companies or others who suffered a loss.

This patent claims the benefit of Provisional Patent 62/295,748, filed on 2016 Feb. 16.

### BACKGROUND—PRIOR ART

U.S. Patents

| Patent number | Kind Code | Issue Date | Patentee |
|---|---|---|---|
| U.S. Pat. No. 6,691,093 | B2 | 2001 Mar. 22 | Allyn M. Shell |
| U.S. Pat. No. 7,149,707 | B2 | 2002 Mar. 15 | Charles Scoble |

U.S. Patent Applications

| Publication number | Kind Code | Publication Date | Applicant |
|---|---|---|---|
| US 20010025253 | A1 | 2001 Sep. 27 | Christopher Heintz, |
| | | | Paul Fino |
| US 20060235749 | A1 | 2006 Oct. 19 | Peter Moc |
| US 20070219871 | A1 | 2007 Sep. 20 | Devon Rolf, |
| | | | Jonathan Burrell |

1. Field of the Invention

This field of monitoring with an eyewitness to observe acts of theft or acts that could result in compensation for an wronged party, which could be an individual, company or other. The field includes the simultaneous monitoring of hundreds of people through the use of video surveillance cameras.

2. Background of the Invention Field

Shoplifting and worker theft in the US cost retailers over 30 billion dollars a year resulting in thinning profit margins for retailers who typically pass on the cost to consumers in the form of higher prices. Retail theft inventory shrinkage is a huge concern for department stores. Security cameras help to cut down on losses by working as a deterrent, and by spotting suspicious activity as it happens. When an act of shoplifting is perceived on camera, security staffers can be quickly deployed to the scene. With cameras providing surveillance coverage, department stores can be monitored and protected only to the extent that there is sufficient security staff to view the video footage either live or recorded. It's simply not cost effective and virtually an impossible task for a retailer's security staff to watch every shopper on every aisle in the store or business. There is a need to be able to cost effectively have additional people to view and review video footage to video record, save and report criminal activity including shoplifting, employee theft and vandalism.

This invention claims a new method of providing sufficient personnel to view footage by signing up members with a multi-level marketing approach, with those members who detected, record and report activity compensated by receiving a share of the compensation received by the multi-level company based on the value of prevented theft or other loss, or monetary recovery from a loss, the percentage determined by contract agreement, depending on the level of the participant.

### DESCRIPTION OF PRIOR ART

No patents or prior art utilizing multi-level marketing to provide additional eyes on videos either live or recorded to find theft or other losses where full or partial recovery of the value lost is possible. There were some patents or patent application with some parts distantly connected to this claimed invention

U.S. Pat. No. 6,691,093 provides a method to accept “payment, transfer the (electronic) product, calculates and pays the commissions, and adds the purchaser's registration information to the multi-level sales database for the product.” The invention claimed in this application will use standard payment systems employed in multi-level marketing organizations, and will not be involved in selling electronically downloadable products.

U.S. Pat. No. 7,149,707 provides a “method (that) includes the steps of forming a multi-level sales force, collecting royalty fees from each participant, placing the collected fees in a revenue sharing pool, and distributing royalty fees from the pool based upon the sponsorship level of each participant relative to the other participants” The claimed invention in this application will use standard procedures in the multi-level industry to accomplish these tasks.

Application US 20010025253 provides a system “for enrolling first-level users, referred by the enrolled user, through a Web interface, tracking internet activity of the users, providing the at least one first-level user with award points earned by the at least one first-level user for the internet activity, and calculating bonus points awarded to the enrolled user based on a first percentage of the award points earned by the at least one first-level user” The invention claimed in this application will use standard tracking systems employed in multi-level marketing organizations.

Application US 20060235749 provides “A multi-level marketing system uniting businesses and individuals as a team to help each other to earn monetary rewards based on sales and profit sharing (optional feature) as governed by a simple yet customizable compensation plan that is tailored to maximize sales.” This application provides the outline of a standard multi-level marketing system with the sign up of members, the calculating of commission, and the payment of commissions based on sales and the level of the participant. This application never proceeded to patent probably because it represents a standard multi-level program. The claimed invention in this application deals with the use of members to monitor video produced by surveillance cameras to observe then record and document theft or other losses that may be absorbed by a business, and then getting compensated for the prevention of theft, or the recovery of losses due to their documented recorded video. The product itself of this method, the documented recorded video from surveillance, documenting theft or other loss, and that s the novel feature of this application's claimed invention.

Application US 20070219871 provides “a method for developing a direct person-to-person multilevel direct affiliate marketing network using electronic communications makes a first person an affiliate member of an affiliate marketing program via an online registration process. An electronic communication is generated that has a unique hyperlink that, when selected, links to a source associated with the affiliate marketing program and identifies the first person so that a commission can be allocated to the first person based upon purchases made at the source as a result of access to the source via the link.” Again this is an application for what appears to be a standard practice for multi-level marketing operations. The invention claimed in this application is not about standard multi-level marketing practices, it is about having a system that encourages many more people to watch live or recorded videos from surveillance cameras to record, document videos of acts that contribute to a loss to a company, individual or organization so they can seek restitution or prosecution.

### DETAILED DESCRIPTION OF THE INVENTION

A method of providing a video surveillance security system comprising:
a. founder member(s) form a multi-level marketing company;
b. the multilevel marketing company acquires or dedicates a central computer server to handle the data from both members and customers
c. written or verbal contract is establish for members, with a requirement for each member to have their own computer and Internet access to view videos;
d. a computer data processing program to run on the server to record pertinent member data regarding, name, level, to which surveillance networks they have access, and records of their document recorded videos submitted to the multi-level marketing company.
e. written or verbal contract is established for individuals, companies or others (customers) looking to prevent losses from theft or other acts;
f. a computer data processing program to run on the server to record pertinent customer data, regarding name, percentage the customer will pay for potential losses or recovered payments, number of cameras, Internet address of each camera, key contact information for business negotiation and contact information in case of a security issues raised by members
g. A compensation and collection program to run on the server to determine amount owed to the multi-level marketing company and amount owed to the members for recorded document videos they produced to either prevent loss or to recover partial or complete compensation.
h. sign up of members with a contract at varying levels, with the members paying a fee, depending on their level, to the multi-level marketing company:
i. members with higher level participation may recruit new members to be in their down line of members;
j. members who recruit other lower level members receive a percentage of those recruited members compensation;
k. The participants are encouraged to continue their own activity rather than simply recruit and sponsor new participants.
l. sign up of members with contract at varying levels, with the members paying a fee, depending on their level, to the multi-level marketing company:
m. Individuals, companies or others are signed up as customers by members or the multi-level marketing company to have their video surveillance viewed and reviewed;
n. video cameras may be already owned, or purchased by the customers;
o. members are given access to live or recorded video footage through a downloaded program that allows Internet access to designated recorded or live video streams from surveillance cameras;
p. members view and review live and recorded video surveillance for acts of theft or other events that could cause lost to individuals, corporations or others;
q. members to record videos and document with date and time showing acts creating loss to the individuals, corporations or others;
r. members may also participate in a video social media game with a catching title where members can reach high levels on a bonus pool depending on their MLM performance recording videos where there is theft or loss to others;
s. documented videos are forwarded to the multi-level marketing company;
t. multi-level marketing companies contact customers, forwarding the documented video showing potential theft or other loss;
u. customer pursues action against person creating theft or other loss;
v. customer reimburses multi-level marketing company a percentage of the averted theft value or a percentage of monies recovered by any means;
w. multi-level marketing company compensates people in based on their recruited members if required;
x. multi-level marketing company pays a percentage to the member who viewed, recorded and documented a potentially theft or other loss to the customer.
y. An option for the multi-level marketing company is for it to set up a reward system/game to highlight high performance from members in recording potential theft and or other loss generating acts.
z. Method of claim 1 where a private policing is established by the multi-level marketing company comprising:
   a. Customer may sign contracts agreeing to private policing policies
   b. Private investigators located in regions with a high number customers;
   c. Mediators located in the regions who may attempt to mediate settlements in minor misdemeanor cases between customers and the offending party;
   d. Customers and persons causing losses to customers agree to proposed settlement s or agree to an alternative settlement;
   e. When settlement monies are received, payment is made to the multi-level marketing company and the customer per contract terms.

### ADVANTAGES OF THE INVENTION

a. Allows many people with spare time, retired people, part time workers or students to provide additional ideas to view and review video from surveillance cameras.
b. Individuals do not need experience and can come from all walks of life.
c. Offers individuals, companies or others a more cost effective solution than increased security staff to viewing videos from surveillance cameras.
d. Provides a proven effect method, multi-level marketing of quickly signing up enough members to provide sufficient review or views of recorded or live videos from surveillance cameras.
e. Offers individuals, companies or others low start-up costs as many will already have surveillance cameras in place.
f. Allows individuals, companies and others to only pay when a theft or other loss is prevented or prosecuted for compensation due to documented video footage from the surveillance cameras.
g. System can be used anywhere, as the members viewing video do not need to be located near the video surveillance cameras whose live or recorded streams they are reviewing.
h. May incorporate a social network game for to show other members the bonus awards based on performance that other members are accumulating. This will add interest to members, and potentially entice additional members to join.
i. A potential private policing network could encourage faster payment as perpetrators seek to avoid court, and could also increase revenue by bring settlements to more cases. This policing network would include some of the framework listed below, but other steps and procedures may be included.
   Customer may sign contracts agreeing to private policing policies
   Private investigators located in regions with a high number customers;
   Mediators located in the regions who may attempt to mediate settlements in minor misdemeanor cases;
   Customers and persons causing losses to customers agree to proposed settlement s or agree to an alternative settlement;
   When settlement monies are received, payment is made to the multi-level marketing company and the customer per contract terms.
   Monies are then paid to members by the multi-level marketing company per the terms of the members agreement.

With this business method for viewing and reviewing video surveillance of security cameras there could be a thousand eyes watching from every corner of the world at any time with the ability to record and report criminal activity. The result to individuals, companies and others should creating a stronger deterrent effect, and greater recovery rate than traditional surveillance cameras/security personnel systems which not only often hardly ever view or review video footage from security cameras, but often record over then that video footage, losing what could be key video evidence forever. This needed business method provides a useful, concrete and tangible result” and its incorporation of the members computer and Internet requirements, and the dedication of a computer server for holding and processing member and customer and data and calculating payments meet the requirements for a business method patent.

### BRIEF DESCRIPTION OF THE DRAWINGS

FIG. 1 is a schematic diagram illustrating the step of forming a multi-level sales force in the method of the present invention.

FIG. 2 is a flow diagram illustrating the steps of the method of the present invention.

### DETAILED DESCRIPTION OF THE DRAWINGS

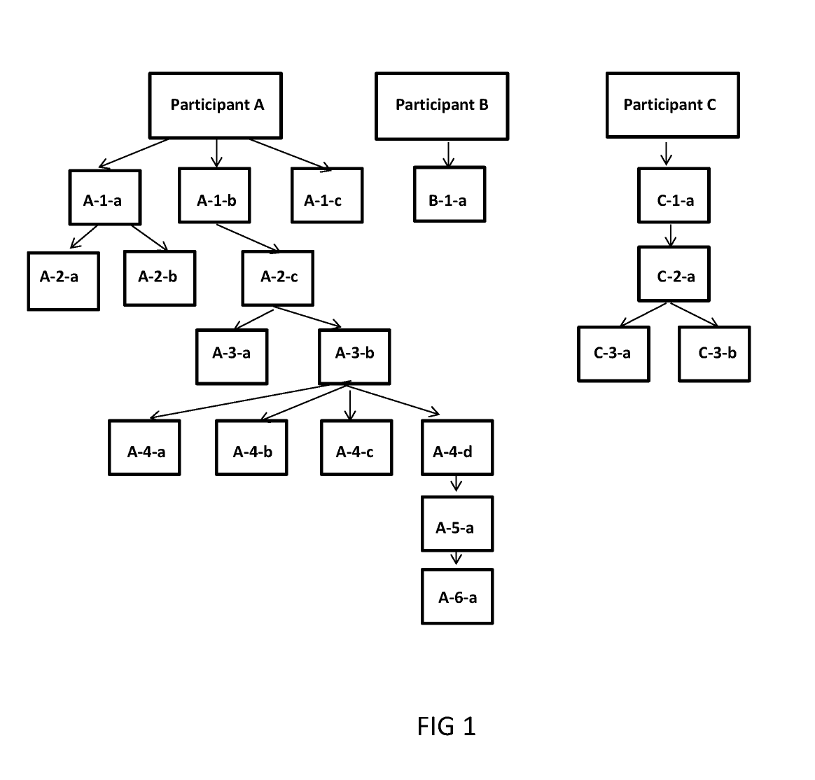

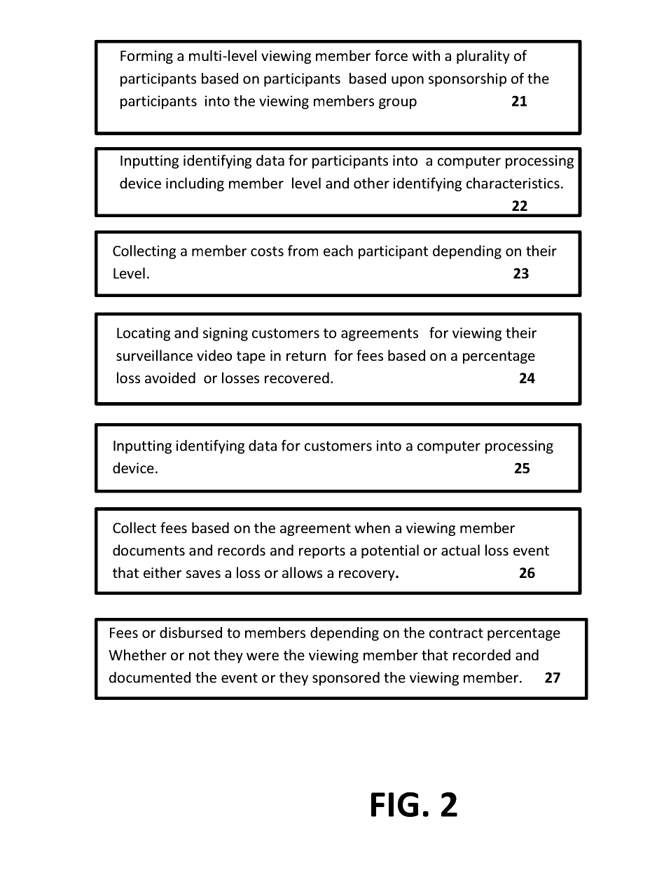

FIG. 1. 1 details the first step of the present invention forming a multilevel viewing force. This step is illustrated in FIG. 2 as step 21, and FIG. 1 illustrates one such force. Assuming that the original founders of the multi-level marketing company initially comprise three viewing members or participants A, B and C. After organization of the multilevel marketing company, participant A recruited three agents A-1-a, A-1-b and A-1-c to view videos from surveillance cameras. Members B and C also directly brought in members B-1-a and C-1-a. The five viewing members who are directly hired by the founders, therefore, form the first or generation level of multi-level viewing members after the founders.

Agent A-1-a can be seen to have recruited two members, namely, A-2-a and A-2-b, while participant or agent A-1-b also brought a viewing member, participant A-2-c, into the system and agent C-1-a brought in a second level participant C-2-b. There are, in the example of FIG. 1, therefore, four participants in the second level of the multi-level viewing member force.

As is shown in the illustration of FIG. 1, the viewing members continues to levels 3, 4 and 5, and it will be seen that founder or original sponsoring participant A has many more viewing members and levels or generations of viewing members than the other two founders, B and C.

FIG. 2 shows the flow of steps in setting up and then operating the multilevel marketing company's operation.

21 revolves around the signing of viewing members wo provide the key element of this invention, a large and diverse population of people capable and able to view or review videos from surveillance cameras to observe theft or other loses to individuals, companies or others.

22 covers the inputting of data regarding each members particular data including but not limited to member level, who sponsors them, what videos are available for them to screen, past reports of possible problems and training received.

23 is the step where member fees are collected based on a participants level, with the first level being the highest and requiring the highest membership cost.

24 is the process of locating customers who would appreciate extra sets of eyes viewing their live streaming, or checking recorded video for incidents of theft or other loss to the customer.

25 is input of customer data into the computer processing device for each customer including but not limited location of video cameras, the Internet address for each camera, agreed percentage for fees paid, viewing members with access to video feeds. Key contact information and other particular characteristics of the customer.

26 is the process by which the multi-level company collects fees for customers based on an event where a viewing member either prevented a loss, or helped the customer recover his or her losses. Compensation is based on a share of the loss prevention or recovering due to a loss that the customer receives.

27 is the point on which a percentage of the fees paid to the multi-level marketing company are paid to the viewing member who saw, recorded and documented an event that resulted in a fee paid by the customer as well as paid to a viewing member who sponsored the viewing member who recorded an event that produced fees.

I claim:

1. A method of operating a multi-level marketing company offering services to customers of members that view or review live or recorded videos from video surveillance cameras, comprising:
a. founding members forming the multi-level marketing company,
b. forming a multi-level viewing members force based upon sponsorship of participants into a member viewing force,
c. the multilevel marketing company acquires or dedicates a central computer server to handle the data from both members and customers
d. members signing agreements with designated membership costs and compensation rates based on their level within the organization; with a requirements for each member to have their own computer and Internet access to view videos;
e. a computer data processing program to run on the server to record pertinent member data regarding, name, level, what surveillance networks they have access to, and records of their document recorded videos submitted to the multi-level marketing company for possible compensation;
f. written or verbal contract is established for individuals, companies or others (customers) looking to prevent losses from theft or other acts;
g. a computer data processing program to run on the server to record pertinent customer data, regarding name, percentage the customer will pay for potential losses or recovered payments, number of cameras, Internet address of each camera, key contact information for business negotiation and contact information in case of a security issues raised by members
h. A compensation and collection program to run on the server to determine amount owed to the multi-level marketing company and amount owed to the members for recorded document videos they produced to either prevent loss or to recover partial or complete compensation.
i. locating and signing contracts with individuals, companies or others (customers) who need a better or more cost effective review of their video from surveillance cameras;
j. those contracts with customers committing customers to paying as compensation fees a percentage of losses avoided, or compensation for losses occurred and then recovered, by customers from documented videos recorded and collected by members;
k. established procedures for collecting those fees from customers;
l. viewing members being given Internet access to live and recorded video streams from surveillance cameras of a specified group of customers;
m. viewing members being given instructions on how to record and document video recordings of potential or actual loss events to the customers
n. fees from customers placed into a revenue sharing pool at the multi-level marketing company;
o. the compensation of each viewing member based upon the revenue generated, and their level in the organization by the recorded and document videos of loss or potential loss events sale to customers;

2. The method of claim 1, wherein the membership costs for the first membership level is greater than the membership fee for the second membership level, and the membership costs for subsequent membership levels is lower than the preceding level.

1. The method of claim 1 where members are also rewarded for signing up customers for the service of having the videos from their surveillance cameras viewed either live as recordings.

2. The method of claim 1 where the multi-level marketing company sets up a reward system/game to highlight high performance from members in recording potential theft and or other loss generating acts.

3. Method of claim 1 where a private policing is established by the multi-level marketing company comprising:
a. Customer may sign contracts agreeing to private policing policies
b. Private investigators located in regions with a high number customers;
c. Mediators located in the regions who may attempt to mediate settlements in minor misdemeanor cases;
d. Customers and persons causing losses to customers agree to proposed settlement s or agree to an alternative settlement;
e. When settlement monies are received, payment is made to the multi-level marketing company and the customer per contract terms.
